(19) United States
(12) Patent Application Publication
(10) Pub. No.: US 2006/0265867 A1
(43) Pub. Date: Nov. 30, 2006

(54) Use of ultrasonic horn to mechanically secure hooks to a smooth material web

(75) Inventor: Michael R. Schaap, Sheboygan, WI (US)

Correspondence Address: RYAN KROMHOLZ & MANION, S.C., POST OFFICE BOX 26618, MILWAUKEE, WI, 53226, US

(73) Assignee: Curt G. Joa, Inc.

(21) Appl. No.: 11/141,597

(22) Filed: May 31, 2005

(51) Int. Cl. B32B 37/00

(52) U.S. Cl. 29/821; 156/73.6; 29/428; 29/521

(57) ABSTRACT

An apparatus and method of temporarily coupling a hook material to a fibrous non-loop material by introducing the hook material to the non-loop material and ultrasonically vibrating at least one of the materials to cause temporary engagement between the two materials.

### BACKGROUND OF THE INVENTION

This invention relates to improvements in methods of manufacturing disposable diaper fasteners of the type which use an adhesive bearing strip of hook and loop material to retain the diaper on a body such as that of an infant or incontinent adult.

One objective of diaper machinery manufacturers is to provide for applying fastener strips to a diaper web at high speed, using the least amount of material, and using the least complex and most reliable apparatus. Another objective is to provide fasteners that are easy to use and provide a secure attachment from one part of the diaper to another so the diaper will be retained snugly on the body.

Typically, the fastener strips are cut from a roll of paper tape or similar material which has one of its surface coated with a pressure sensitive adhesive, or which uses hook and loop fasteners. Adhesive segments are transferred to a moving diaper web.

Hook and loop fasteners have become more increasingly used to adhere diaper portions around the waist of a user. Hook and loop fastening systems are widely used in disposable articles such as diapers and incontinence products. Often, the hook component is not intended to engage the loop component until the consumer puts the disposable article into use. Stabilizing the hook component in a machinery process used to make a disposable article is difficult. Sometimes additional materials that have a lint or “fuzzy” surface are added to the disposable article just to provide a surface to stabilize the hook component in a temporary position during the machine process used to make the disposable article. This introduces increased machine process complexity and material costs. In other cases, the hook component is allowed to negotiate the machine process in an unstable configuration that is not conducive to high-speed processes or to consistent folding and packaging of the disposable article.

Therefore, it is desirable to have a method whereby the hook component can be temporarily attached to an existing non-loop material, such as a smooth nonwoven material, to maintain stability of the hook component in the machine process.

### SUMMARY OF THE INVENTION

The present invention uses an ultrasonic bonding system in the machine process to vibrate the hook components against a relatively smooth material web that is typically ineffective at engaging hook components. The vibration of the hook components against the relatively smooth material web causes the hooks to “wiggle” their way into the gaps and between the fibers of the relatively smooth material. The entanglement of the hook components with the fibers of the relatively smooth material is sufficient to stabilize the hook material through the remainder of the machine process. The gap that would typically be used between the ultrasonic horn and the smooth anvil for actual bonding applications is increased slightly so the hook component does not fuse to the relatively smooth material.

This invention uses an ultrasonic bonding system in an unusual method that does not involve actual bonding of materials together, but instead creates a loose attachment. For stability in a moving machine process, the hook component of a hook and loop fastening system may need to be temporarily fixed to a material web or to a component of a material web that is not well suited to engage the hook components. An ultrasonic bonding system is used to “wiggle” the hooks of a hook-and-loop component into a non-loop material to entangle the hooks that otherwise would not entangle with simple contact and pressure. Thus engaged, the hook component is stabilized and is reliably carried through the machine process.

### BRIEF DESCRIPTION OF THE DRAWINGS

FIG. 1 is a diagrammatic side view of a Prior Art process;

FIG. 2a is an initial, undesirable downstream travel configuration of non-loop material with exposed and flying hook ear;

FIG. 2b is a desirable downstream travel configuration of non-loop material coupled with the folded hook ear, non-hook material exposed;

FIG. 3 is a schematic view of an apparatus for folding a flying hook ear, tucking the ear, and bonding the hook ear to non-loop material for downstream travel.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

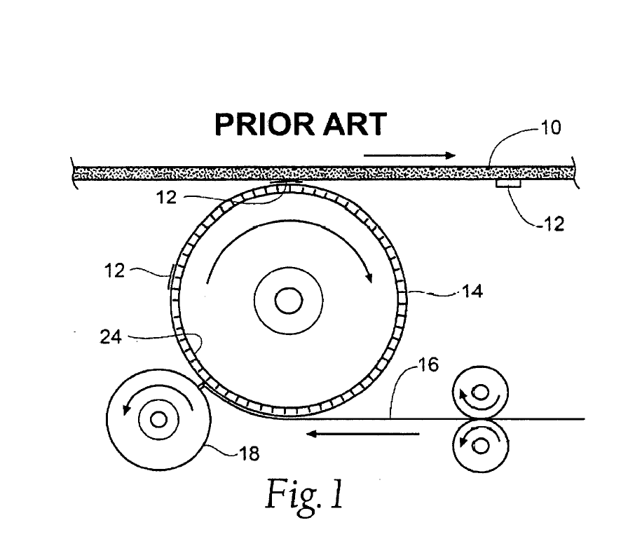

For background purposes, FIG. 1 is shown as a diagrammatic illustration of a prior art process for applying tabs to webs in a diaper making process. Tabs 12 are coupled to the web 10. For purposes of the present invention, tabs 12 comprise a hook material which is often used to be secured by the end user to a loop material (not shown) on a corresponding diaper of the end user when worn. Web 10 is a composite material used in formation of diapers which is generally formed of various layers of material such as plastic back sheets, absorbent pads and nonwoven topsheets. For purposes of the present invention, web 10 comprises a non-loop material, not ordinarily associated with coupled to a hook material, which ordinarily requires loops for coupling.

The non-loop material is preferably fibrous material, so that the fibers of the non-loop material are available to entangle the hooks.

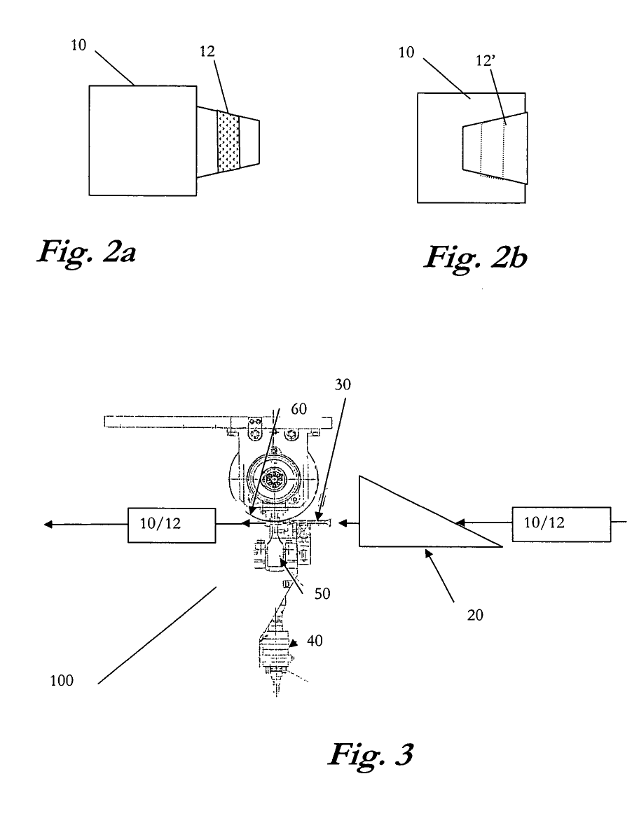

Referring now to FIG. 2a, an initial, undesirable downstream travel configuration of fibrous non-loop material 10 with exposed and flying hook ear 12 is shown. The ear 12 comprises two portions, a first portion shown of hook material and an underside 12′ of non-hook material. Ordinarily, the hook material is provided on the ear portion in a strip although other configurations of hook material are of course capable of being used in the present invention.

If this segment were to travel downstream for further diaper manufacturing processing in the initial and undesirable configuration shown in FIG. 2a, and negotiate the remaining machine processes (not shown) in this unstable configuration, further high-speed processes or consistent folding and packaging of the disposable article could all be impaired.

Therefore, it is the object of the present invention to provide, as shown in FIG. 2b, a desirable downstream travel configuration of non-loop material 10 coupled with the folded hook material of ear 12, exposing fibrous non-hook material 12′ and providing for a compacted downstream negotiation and slimmer profile without flying parts.

Referring now to FIG. 3, a schematic view of an apparatus 100 for folding the flying hook ear 12, tucking the ear 12, and bonding the hook ear 12 to fibrous non-loop material 10 for downstream travel is shown.

The apparatus 100 for accomplishing this task first comprises a folder 20 for initially folding the ear 12 over towards the fibrous non-loop material 10. After being folded by the folder 12, the hook material 12 will not be bonded to the non-loop material 10, so a funnel 30 is provided to keep this proximity between the hook material 12 and fibrous non-loop material 10 formed by the folder 30 until the temporary bonding can take place. The funnel 30 comprises a top and bottom portion for holding the two portions 12 and 10 in proximity.

Next, the traveling combination of the hook material 12 and fibrous non-loop material 10 encounters a horn 50 which is ultrasonically vibrated by an amplifier stack 40. The horn ultrasonically vibrates the combination of the hook material 12 and fibrous non-loop material 10 against anvil 60. The vibration of the hook 10 components against the relatively smooth fibrous non-loop material 10 web causes the hooks to “wiggle” their way into the gaps and between the fibers of the relatively smooth material. The entanglement of the hook components 12 with the fibers of the relatively smooth material 10 is sufficient to stabilize the hook material 12 through the remainder of the machine process. In a best mode, a gap that is typical for actual bonding applications between ultrasonic horn 50 and the smooth anvil 60 is increased slightly so the hook component 12 does not fuse to the relatively smooth material 10.

A preferred frequency of vibration in ultrasonic bonding units, such as that identified at amplifier stack 40 and horn 50 is in the ultrasound range (20 kHz<f<1 GHz.) Typical would be 20 kHz systems and 35 kHz systems.

After being ultrasonically wiggled by horn 50, the desirable downstream travel configuration is provided of fibrous non-loop material 10 coupled with the folded hook material of ear 12, exposing non-hook material 12′ and providing for a compacted downstream negotiation and slimmer profile without flying parts of the combination. It is noted that it is not desired to bond the materials together, but instead to create a loose attachment between the two materials, so that the end user can easily disconnect the materials and reconnect the hook material 12 with its conventional loop counterpart (not shown).

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An apparatus for temporarily coupling materials together, the apparatus comprising:
a traveling web comprising a hook material and a fibrous non-loop material, said hook material in contact with said fibrous non-loop material;
a vibrated horn;
an anvil;
said vibrated horn engaging said hook material with said fibrous non-loop material against said anvil to couple said hook material and said non-loop material together.

2. An apparatus according to claim 1, the apparatus further comprising an amplifier stack coupled to said horn to vibrate said horn.

3. An apparatus according to claim 1, wherein said horn is vibrated ultrasonically.

4. An apparatus according to claim 1, the apparatus further comprising a folder to fold said hook material into contact with said fibrous non-loop material.

5. An apparatus according to claim 4, the apparatus further comprising a funnel to temporarily hold said hook material into contact with said non-loop material, said funnel engaging said hook material and said fibrous non-loop material prior to said vibrated horn engaging said hook material.

6. An apparatus according to claim 1, wherein said fibrous non-loop material comprises a nonwoven material.

7. An apparatus according to claim 1, wherein said fibrous non-loop material comprises a nonwoven material and an additional material.

8. A method of temporarily coupling a hook material to a fibrous non-loop material, the method comprising:
introducing a hook material to a non-loop material;
ultrasonically vibrating at least one of said hook material and said non-loop material, thereby causing said hook material to entangle with the said non-loop material.
